(19) United States
(12) Patent Application Publication
(10) Pub. No.: US 2009/0284595 A1
(43) Pub. Date: Nov. 19, 2009

(54) COMMUNICATIONS AND SURVEILLANCE SYSTEMS, METHODS, AND APPARATUS

(75) Inventor: Ronald Carter, Matthews, NC (US)

Correspondence Address: TILLMAN WRIGHT, PLLC, PO BOX 49309, CHARLOTTE, NC, 28277-0076, US

(73) Assignee: REVOLUTIONARY CONCEPTS, INC., Matthews, NC (US)

(21) Appl. No.: 12/464,022

(22) Filed: May 11, 2009

Related U.S. Application Data
(60) Provisional application No. 61/052,246, filed on May 11, 2008.

(51) Int. Cl. H04N 5/00

(52) U.S. Cl. 348/143; 348/E05.001

(57) ABSTRACT

A method for communicating with a person at a remote area includes sensing, by a motion sensor of a surveillance module, motion; transitioning, by the surveillance module, from a home configuration, in which a head of the surveillance module is disposed generally in abutment with a bulb of the surveillance module, to an active configuration, in which a head of the surveillance module is not disposed generally in abutment with the bulb; capturing, by a video camera of the surveillance module, video of an area proximate the surveillance module; capturing, by a microphone of the surveillance module, audio proximate the surveillance module; communicating, from the surveillance module, data representative of the captured video and audio; receiving, at the surveillance module, data representative of speech; playing, over a speaker of the surveillance module, the speech; transitioning, by the surveillance module, from the active configuration to the home configuration.

### CROSS-REFERENCE TO RELATED APPLICATION

The present application is a U.S. nonprovisional patent application of, and claims priority under 35 U.S.C. § 119(e) to, U.S. provisional patent application Ser. No. 61/052,246, filed May 11, 2008, which provisional patent application is incorporated by reference herein, and a copy of which is attached hereto as Appendix A.

The present application also hereby incorporates herein by reference
(a) U.S. Pat. No. 7,193,644, issued Mar. 20, 2007, titled “Automated Audio Video Messaging And Answering System”;
(b) U.S. Patent Application Publication No. 2007/0188612, published Aug. 16, 2007, titled “Video System for Individually Selecting and Viewing Events at a Venue”;
(c) U.S. Patent Application Publication No. 2007/0103541, published May 10, 2007, titled “Two-Way Audio-Video Communication Method For Receiving Person At Entrance”.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to communications and surveillance systems, methods, and apparatus.

A need exists for improvement in communications and surveillance systems, methods, and apparatus. This, and other needs, are addressed by one or more aspects of the present invention.

### SUMMARY OF THE INVENTION

The present invention includes many aspects and features. Moreover, while many aspects and features relate to, and are described in, the context of communications and surveillance systems, the present invention is not limited to use only in this context, as will become apparent from the following summaries and detailed descriptions of aspects, features, and one or more embodiments of the present invention.

Accordingly, one aspect of the present invention relates to a surveillance system. An exemplary such system includes a module designed to have two configurations. In the first configuration, the module is positioned substantially below ground level. In the second configurations, the module is positioned substantially above ground level. Additionally, the module may transition between the first configuration and the second configuration by popping upwards above ground level, and may further transition between the second configuration and the first configuration by retracting back below ground level.

In a feature of this aspect of the invention, the module further includes a camera. In a further feature, the camera can pan, tilt, and zoom. Alternatively, the module may include a microphone. Furthermore, the module can monitor an area surrounding the module. In yet another feature of this aspect of the invention, two way communication is possible between the module and a remote device. In other features, the remote device is a handheld device or a dedicated device. In a feature of this aspect of the invention, a surrounding area of the module is displayed to a remote device.

Another aspect of the invention relates to a method of surveilling an area. An exemplary such method includes installing a module in an area of ground proximate the area to be surveilled. The module being installed is designed to have two configurations, a first configuration, in which the module is positioned substantially below ground level, and a second configuration, in which the module is positioned substantially above ground level. Furthermore, the module may transition between the first configuration and the second configuration by popping upwards above ground level, and may further transition between the second configuration and the first configuration by retracting back below ground level.

In a feature of this aspect of the invention, the module further includes a camera. In a further feature, the camera can pan, tilt, and zoom. Alternatively, the module may include a microphone. Furthermore, the module can monitor an area surrounding the module. In yet another feature of this aspect of the invention, two way communication is possible between the module and a remote device. In other features, the remote device is a handheld device or a dedicated device. In a feature of this aspect of the invention, a surrounding area of the module is displayed to a remote device.

Another aspect of the present invention relates to a surveillance system that includes a module designed to have two configurations, a first and a second. In the second configuration the module is positioned vertically below where the module is positioned in the first configuration. Further, the module may transition between the first configuration and the second configuration by popping upwards, and may further transition between the second configuration and the first configuration by retracting downwards.

In a feature of this aspect of the invention, the module further includes a camera. In a further feature, the camera can pan, tilt, and zoom. Alternatively, the module may include a microphone. Furthermore, the module can monitor an area surrounding the module. In yet another feature of this aspect of the invention, two way communication is possible between the module and a remote device. In other features, the remote device is a handheld device or a dedicated device. In a feature of this aspect of the invention, a surrounding area of the module is displayed to a remote device. In another feature, the system includes a pole to which the module is attached.

Another aspect of the invention relates to a method of surveilling an area. An exemplary such method includes installing a module in an area of ground proximate the area to be surveilled. The module being installed is designed to have two configurations, a first configuration and a second. In the second configuration the module is positioned vertically below where the module is positioned in the first configuration. Further, the module may transition between the first configuration and the second configuration by popping upwards, and may further transition between the second configuration and the first configuration by retracting downwards back below ground level.

In a feature of this aspect of the invention, the module further includes a camera. In a further feature, the camera can pan, tilt, and zoom. Alternatively, the module may include a microphone. Furthermore, the module can monitor an area surrounding the module. In yet another feature of this aspect of the invention, two way communication is possible between the module and a remote device. In other features, the remote device is a handheld device or a dedicated device. In a feature of this aspect of the invention, a surrounding area of the module is displayed to a remote device.

Another aspect of the present invention relates to a communications and surveillance module. An exemplary such apparatus includes a head, a bulb disposed generally underground, and a stalk connecting the head and the bulb. The head of the apparatus has a camera, a microphone, a speaker, and a sensor. The module is configured to transition between a home configuration, in which the head is generally in abutment with the bulb, and an active configuration, in which the head is not located in abutment with the bulb. Furthermore, when the module is in the active configuration, the camera and microphone provide surveillance of an area proximate the module.

Another aspect of the present invention relates to a communications and surveillance module. An exemplary such apparatus includes a stake configured for insertion into the ground, and a head having a camera, a microphone, a speaker, and a motion sensor, configured to swivel and pivot relative to the stake. The module is configured for electronic communications with one or more remote devices, such electronic communications including communication of data representative of video recorded by the camera of the module, and data representative of audio recorded by the microphone of the module. Furthermore, the module includes an active configuration, in which the camera and microphone capture video and audio of an area proximate the module, and an inactive configuration, in which the camera and microphone do not so capture video and audio. Additionally, the communications and surveillance module is configured to transition from the inactive configuration to the active configuration upon sensing of motion by the motion sensor.

Another aspect of the present invention relates to a communications and surveillance system. An exemplary such system includes a computer system having a storage device, one or more communications and surveillance modules, and a remote device. Each module includes a camera, a microphone, a speaker, and a sensor, and has an active configuration, in which the camera and microphone capture video and audio of an area proximate the module, and an inactive configuration, in which the camera and microphone do not so capture video and audio. Each module is configured to transition from the inactive configuration to the active configuration upon sensing of motion by the motion sensor. Further more, the system is configured for electronic communications of video and audio captured by the one or more communications and surveillance modules to the remote device.

In a feature of this aspect of the invention, the system is configured for electronic communications of video and audio captured by the one or more communications and surveillance modules to the remote device via the computer system. In a further feature of this aspect of the present invention, the system further includes a router, and the system is configured for electronic communications of video and audio captured by the one or more communications and surveillance modules to the remote device via a router. In yet another feature, the system is configured for electronic communications of video and audio captured by the one or more communications and surveillance modules to the remote device via a wireless RF link. In still a further feature, the system is configured for electronic communications of video and audio captured by the one or more communications and surveillance modules to the remote device via a WiFi link. In yet another feature, the one or more modules are configured to collectively transition to the active configuration upon sensing of motion by the motion sensor of any of the modules.

Another aspect of the invention relates to a communications and surveillance system. An exemplary such system includes a computer system having a storage device, one or more communications and surveillance modules, each module having camera, a microphone, a speaker, and a sensor, and a dedicated device. Further, each module has an active configuration, in which the camera and microphone capture video and audio of an area proximate the module, and an inactive configuration, in which the camera and microphone do not capture video and audio. Additionally, the system is configured for electronic communications of video and audio captured by the one or more communications and surveillance modules to the dedicated device.

In a feature of this aspect of the invention, the system is configured for electronic communications of video and audio captured by the one or more communications and surveillance modules to the dedicated device via the computer system. In another feature, the system further includes a router and is configured for electronic communications of video and audio captured by the one or more communications and surveillance modules to the dedicated device via a router. In yet another feature, the system is configured for electronic communications of video and audio captured by the one or more communications and surveillance module to the dedicated device via a wireless RF link. In still another feature of this aspect of the present invention, the system is configured for electronic communications of video and audio captured by the one or more communications and surveillance modules to the dedicated device via a WiFi link. In yet another feature, the one or more modules are configured to collectively transition to the active configuration upon sensing of motion by the motion sensor of any of the modules.

Another aspect of the present invention relates to a communications and surveillance system. An exemplary such system includes a computer system having a storage device, one or more communications and surveillance modules, each having a camera, a microphone, a speaker, and a sensor, a module activator configured to activate the one or more communications and surveillance modules, and a remote device configured for electronic communications with the module activator. Moreover, each module has an active configuration, in which the camera and microphone capture video and audio of an area proximate the module, and an inactive configuration, in which the camera and microphone do not so capture video and audio, and each module is configured to transition from the inactive configuration to the active configuration upon sensing of motion by the motion sensor. Furthermore, the system is configured for electronic communications of video and audio captured by the one or more communications and surveillance modules to the remote device. The system is further configured to allow a user to activate the one or more communications and surveillance modules using the remote device.

In a feature of this aspect of the invention, the remote device is configured for electronic communications with the module activator via the computer system. In another feature, the remote device is a handheld device. In another feature, the remote device is configured for electronic communications with the module activator via the Internet. In still another feature, the remote device is configured for electronic communications with the module activator via the public switched telephone network (PSTN).

Another aspect of the present invention relates to a communications and surveillance system. An exemplary such system includes a computer system having a storage device, one or more communications and surveillance modules, each having a camera, a microphone, a speaker, and a sensor, a module activator configured to activate the one or more communications and surveillance modules, and a dedicated device configured for electronic communications with the module activator. Moreover, each module has an active configuration, in which the camera and microphone capture video and audio of an area proximate the module, and an inactive configuration, in which the camera and microphone do not so capture video and audio, and each module is configured to transition from the inactive configuration to the active configuration upon sensing of motion by the motion sensor. Furthermore, the system is configured for electronic communications of video and audio captured by the one or more communications and surveillance modules to the dedicated device. The system is further configured to allow a user to activate the one or more communications and surveillance modules using the dedicated device.

In a feature of this aspect of the invention, the dedicated device is configured for electronic communications with the module activator via the computer system.

Another aspect of the present invention relates to a communications and surveillance system. An exemplary such system includes a computer system having a storage device, and one or more communications and surveillance modules, each having a camera, a microphone, a speaker, and a sensor. Moreover, each module has an active configuration, in which the camera and microphone capture video and audio of an area proximate the module, and an inactive configuration, in which the camera and microphone do not so capture video and audio, and each module is configured to transition from the inactive configuration to the active configuration upon sensing of motion by the motion sensor. Furthermore, the system is configured for electronic communications of video and audio captured by the one or more communications and surveillance modules to the computer system. The video and audio communicated to the computer system is stored on the storage device of the computer system.

Another aspect of the present invention relates to a communications and surveillance system. An exemplary such system includes a computer system running a user application and having a storage device, and one or more communications and surveillance modules, each having a camera, a microphone, a speaker, and a sensor. Moreover, each module has an active configuration, in which the camera and microphone capture video and audio of an area proximate the module, and an inactive configuration, in which the camera and microphone do not so capture video and audio, and each module is configured to transition from the inactive configuration to the active configuration upon occurrence of a trigger event. Furthermore, the system is configured for electronic communications of video and audio captured by the one or more communications and surveillance modules to the computer system. The video and audio communicated to the computer system is stored on the storage device of the computer system. The user application allows a user to select a trigger event from among a plurality of trigger events.

In a feature of this aspect of the invention, at least one of the one or more communications and surveillance modules is attached to a building. In another feature, at least one of the one or more communications and surveillance modules is attached to a construction trailer. In still another feature, at least one of the one or more communications and surveillance modules includes a stake which is inserted into the ground. In a further feature, at least one of the one or more communications and surveillance modules includes a spike which is inserted into the ground. In yet another feature, at least one of the one or more communications and surveillance modules is configured to pop up.

In a feature of this aspect of the present invention, the remote device has a microphone, and the system is configured to communicate audio captured by the microphone of the remote device to at least one module of the one or more communication and surveillance modules for playing by the speaker of the at least one module. In yet another feature, the dedicated device includes a microphone, and the system is configured to communicate audio captured by the microphone of the dedicated device to at least one module of the one or more communication and surveillance modules for playing by the speaker of the at least one module.

Another aspect of the invention relates to an audio-video communication system. An exemplary such system includes a plurality of communications and surveillance modules distributed throughout an outdoor area, each module having a sensor, a video camera, a microphone, and a speaker; a computer system running a software application; a router enabling communication between the module and the computer system; a recording component that records video and audio communication that is communicated to and from the exterior module; and a playing component that plays video and audio communication recorded by the recording component. The software application has a graphic user interface that enables a user to view images and streaming video from the camera of one or more of the plurality of modules, and that enables the coordination of multiple modules and user defined responses to prompts and events.

Another aspect of the present invention relates to a method for communicating with a person at a remote area. An exemplary such method includes sensing, by a motion sensor of a surveillance modules, motion; transitioning, by the surveillance module, from a home configuration, in which a head of the surveillance module is disposed generally in abutment with a bulb of the surveillance module, to an active configuration, in which a head of the surveillance module is not disposed generally in abutment with the bulb; capturing, by a video camera of the surveillance module, video of an area proximate the surveillance module; capturing, by a microphone of the surveillance module, audio proximate the surveillance module; communicating, from the surveillance module, data representative of the captured video and audio; receiving, at the surveillance module, data representative of speech; playing, over a speaker of the surveillance module, the speech; and transitioning, by the surveillance module, from the active configuration to the home configuration.

Another aspect of the present invention relates to a method for surveilling a remote area. An exemplary such method includes sensing, by a motion sensor of a surveillance module of a plurality of surveillance modules, motion; transitioning, by each surveillance module, from a home configuration, in which a head of the surveillance module is disposed generally in abutment with a bulb of the surveillance module, to an active configuration, in which a head of the surveillance module is not disposed generally in abutment with the bulb; capturing, by a video camera of each surveillance module, video of an area; capturing, by a microphone of each surveillance module, audio; communicating, from each surveillance module, data representative of the captured video and audio to a computer system; playing, at the computer system, video and audio captured by at least one of the surveillance modules; and transitioning, by each surveillance module, from the active configuration to the home configuration.

Another aspect of the present invention relates to a method for communicating with a person at a remote area. An exemplary such method includes sensing, by a motion sensor of a surveillance module, motion; transitioning, by the surveillance module, from a home configuration, in which a head of the surveillance module is disposed generally in abutment with a bulb of the surveillance module, to an active configuration, in which a head of the surveillance module is not disposed generally in abutment with the bulb; capturing, by a video camera of the surveillance module, video of an area proximate the surveillance module; capturing, by a microphone of the surveillance module, audio proximate the surveillance module; communicating, from the surveillance module, data representative of the captured video and audio to a remote device; playing, at the remote device, video and audio captured by at least one of the surveillance modules; capturing, at the remote device, speech of a user; communicating, from the remote device to the surveillance module, data representative of the speech of the user; receiving, at the surveillance module, the data representative of the speech of the user; playing, over a speaker of the surveillance module, a reproduction of the speech; and transitioning, by the surveillance module, from the active configuration to the home configuration.

Another aspect of the present invention relates to a method for communicating with a person at a remote area. An exemplary such method includes sensing, by a motion sensor of a surveillance module, motion; transitioning, by the surveillance module, from a home configuration, in which a head of the surveillance module is disposed generally in abutment with a bulb of the surveillance module, to an active configuration, in which a head of the surveillance module is not disposed generally in abutment with the bulb; capturing, by a video camera of the surveillance module, video of an area proximate the surveillance module; capturing, by a microphone of the surveillance module, audio proximate the surveillance module; communicating, from the surveillance module, data representative of the captured video and audio to a dedicated device; playing, at the dedicated device, video and audio captured by at least one of the surveillance modules; capturing, at the dedicated device, speech of a user; communicating, from the dedicated device to the surveillance module, data representative of the speech of the user; receiving, at the surveillance module, the data representative of the speech of the user; playing, over a speaker of the surveillance module, a reproduction of the speech; and transitioning, by the surveillance module, from the active configuration to the home configuration.

Another aspect of the present invention relates to a method for communicating with a person at a remote area. An exemplary such method includes sensing, by a motion sensor of a communications module, motion; transitioning, by the communications module, from an inactive configuration, in which a camera, microphone, and speaker of the module are inoperative, to an active configuration, in which the camera, microphone, and speaker are operative; capturing, by a video camera of the communications module, video of an area proximate the communications module; capturing, by a microphone of the communications module, audio proximate the communications module; communicating, from the communications module, data representative of the captured video and audio to a remote device; playing, at the remote device, video and audio captured by at least one of the communications modules; capturing, at the remote device, speech of a user; communicating, from the remote device to the communications module, data representative of the speech of the user; receiving, at the communications module, the data representative of the speech of the user; playing, over a speaker of the communications module, a reproduction of the speech; and transitioning, by the communications module, from the active configuration to the inactive configuration.

Another aspect of the present invention relates to a method for communicating with a person at a remote area. An exemplary such method includes sensing, by a motion sensor of a communications module, motion; transitioning, by the communications module, from an inactive configuration, in which a camera, microphone, and speaker of the module are inoperative, to an active configuration, in which the camera, microphone, and speaker are operative; capturing, by a video camera of the communications module, video of an area proximate the communications module; capturing, by a microphone of the communications module, audio proximate the communications module; communicating, from the communications module, data representative of the captured video and audio to a dedicated device; playing, at the dedicated device, video and audio captured by at least one of the communications modules; capturing, at the dedicated device, speech of a user; communicating, from the dedicated device to the communications module, data representative of the speech of the user; receiving, at the communications module, the data representative of the speech of the user; playing, over a speaker of the communications module, a reproduction of the speech; and transitioning, by the communications module, from the active configuration to the inactive configuration.

Another aspect of the present invention relates to a method for communicating with a person at a remote area. An exemplary such method includes engaging, by a user, a module activator; activating, by the module activator, a communications module; transitioning, by the communications module, from an inactive configuration, in which a camera, microphone, and speaker of the module are inoperative, to an active configuration, in which the camera, microphone, and speaker are operative; capturing, by a video camera of the communications module, video of an area proximate the communications module; capturing, by a microphone of the communications module, audio proximate the communications module; communicating, from the communications module, data representative of the captured video and audio to a remote device; playing, at the remote device, video and audio captured by at least one of the communications modules; capturing, at the remote device, speech of a user; communicating, from the remote device to the communications module, data representative of the speech of the user; receiving, at the communications module, the data representative of the speech of the user; playing, over a speaker of the communications module, a reproduction of the speech; and transitioning, by the communications module, from the active configuration to the inactive configuration.

Another aspect of the present invention relates to a method for communicating with a person at a remote area. An exemplary such method includes engaging, by a user, a module activator; activating, by the module activator, a communications module; transitioning, by the communications module, from an inactive configuration, in which a camera, microphone, and speaker of the module are inoperative, to an active configuration, in which the camera, microphone, and speaker are operative; capturing, by a video camera of the communications module, video of an area proximate the communications module; capturing, by a microphone of the communications module, audio proximate the communications module; communicating, from the communications module, data representative of the captured video and audio to a dedicated device; playing, at the dedicated device, video and audio captured by at least one of the communications modules; capturing, at the dedicated device, speech of a user; communicating, from the dedicated device to the communications module, data representative of the speech of the user; receiving, at the communications module, the data representative of the speech of the user; playing, over a speaker of the communications module, a reproduction of the speech; and transitioning, by the communications module, from the active configuration to the inactive configuration.

In addition to the aforementioned aspects and features of the present invention, it should be noted that the present invention further encompasses the various possible combinations and subcombinations of such aspects and features.

### BRIEF DESCRIPTION OF THE DRAWINGS

One or more preferred embodiments of the present invention now will be described in detail with reference to the accompanying drawings, wherein the same elements are referred to with the same reference numerals, and wherein,

FIG. 1 is a block diagram of a preferred communications and surveillance system in accordance with one or more preferred embodiments of the present invention;

FIG. 2A is a front view illustration of a communications and surveillance module in accordance with one or more preferred embodiments of the present invention;

FIG. 2B is a front view illustration of a communications and surveillance module in accordance with one or more preferred embodiments of the present invention;

FIG. 2C is a front perspective view of a communications and surveillance module shown placed in the ground in accordance with one or more preferred embodiments of the present invention;

FIG. 3A is a front perspective view of a communications and surveillance module having a head connected to a stake, in accordance with one or more preferred embodiments of the present invention;

FIG. 3B is a front perspective view of a communications and surveillance module mounted to a pole, in accordance with one or more preferred embodiments of the present invention;

FIG. 4A is a front view of a communications and surveillance module having a head connected to a spike, in accordance with one or more preferred embodiments of the present invention;

FIG. 4B is a perspective view of a communications and surveillance module mounted to a building, in accordance with one or more preferred embodiments of the present invention;

FIG. 5 is a block diagram that illustrates an exemplary use scenario for a system employing pop up modules, in accordance with one or more preferred embodiments of the present invention;

FIG. 6 is a block diagram that illustrates a use scenario involving a module and is not configured to pop up, in accordance with one or more preferred embodiments of the present invention;

FIG. 7A is a block diagram that illustrates an exemplary use scenario for use in a construction context, and more specifically in a pre-construction context, in accordance with one or more preferred embodiments of the present invention;

FIG. 7B is a block diagram that illustrates an exemplary use scenario for use in a construction context, and more specifically in a post-construction context, in accordance with one or more preferred embodiments of the present invention; and

FIG. 8 is a schematic diagram illustrating an exemplary DVMS system, including a plurality of modules, a computer system, and a module activator in which the modules are distributed throughout the yard of a residential property, in accordance with one or more preferred embodiments of the present invention.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

### Communications and Surveillance System

A communications and surveillance system in accordance with one or more preferred embodiments includes a computerized controller and one or more peripheral devices.

Preferably, such a system is designed to allow both direct communications, by peripheral devices, with the computerized controller, and indirect communications, by peripheral devices, through the Internet and the public switched telephone network (PSTN). Peripheral devices configured for direct communications with the computerized controller are in direct contact via either a wireless radio frequency (RF) link, or a wired line. Devices in communication via an RF link communicate via short-range RF waves that have a direct view, and these peripheral devices are able to receive and convey messages to other similar peripheral devices, as well as the computerized controller.

More remote peripheral devices, i.e. remote devices, generally are in communication via established institutional channels, such as the Internet, satellite systems, PSTN, cell systems, cable systems, and, to a lesser extent, long wavelength systems. Remote devices are selected from the group consisting of cell phones, telephones, video-cell phones, computers, personal digital assistants, video-personal digital assistants, satellite telephones, transceivers, pagers, and other analog or digital communication devices.

Further, Wi-Fi connections may be utilized to connect a handheld device or a dedicated device where necessary. A Wi-Fi connection may allow for the use of all handheld devices which are compatible with the network.

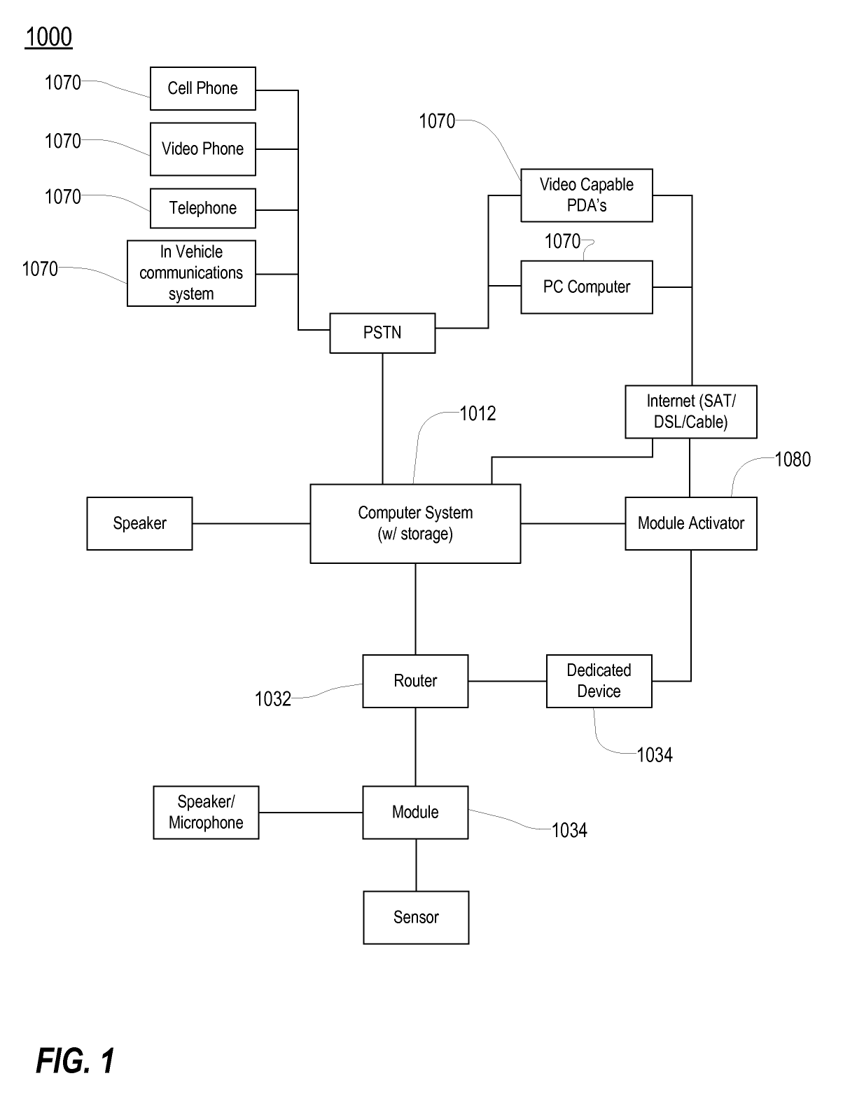

FIG. 1 illustrates a preferred communications and surveillance system 1000 in which the computerized controller comprises a computer system 1012 which preferably includes some or all of the functionality of a computerized controller as disclosed in the incorporated references, such as U.S. Pat. No. 7,193,644 (for example, the computer system 1012 preferably has a battery backup, and a means for detecting a loss in electrical power). As illustrated, in the system 1000, at least one of the peripheral devices comprises a communications and surveillance module 1010 having a camera.

### Communications and Surveillance Modules

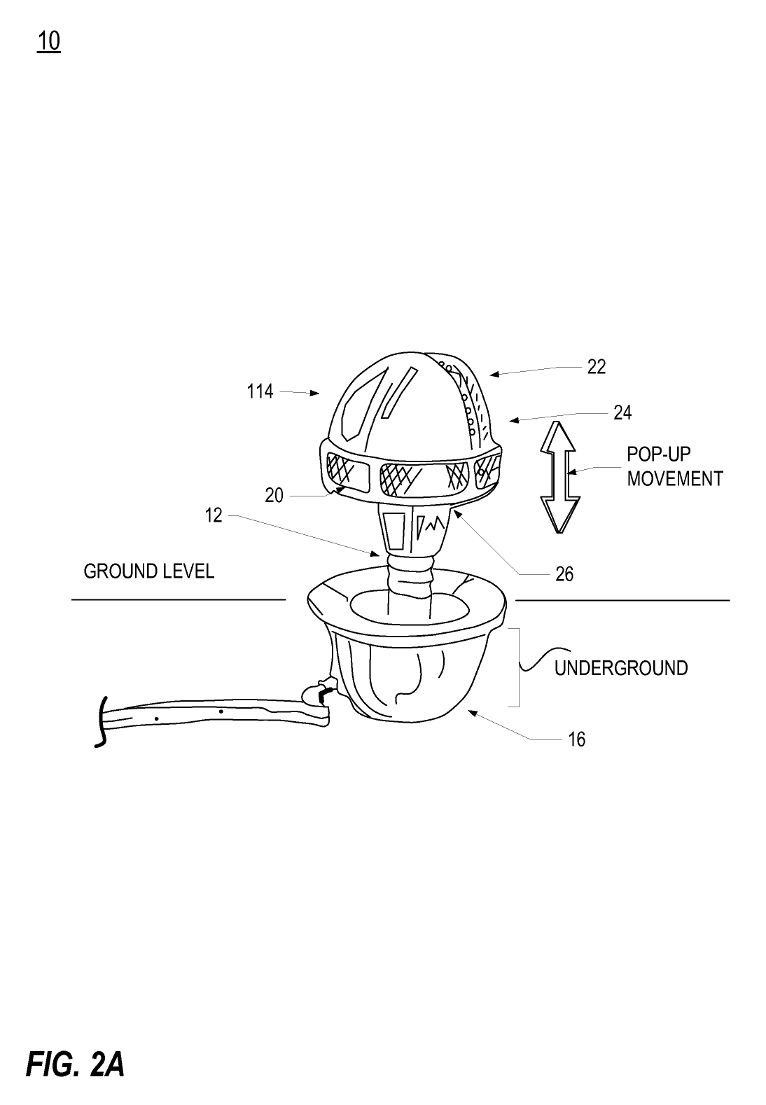

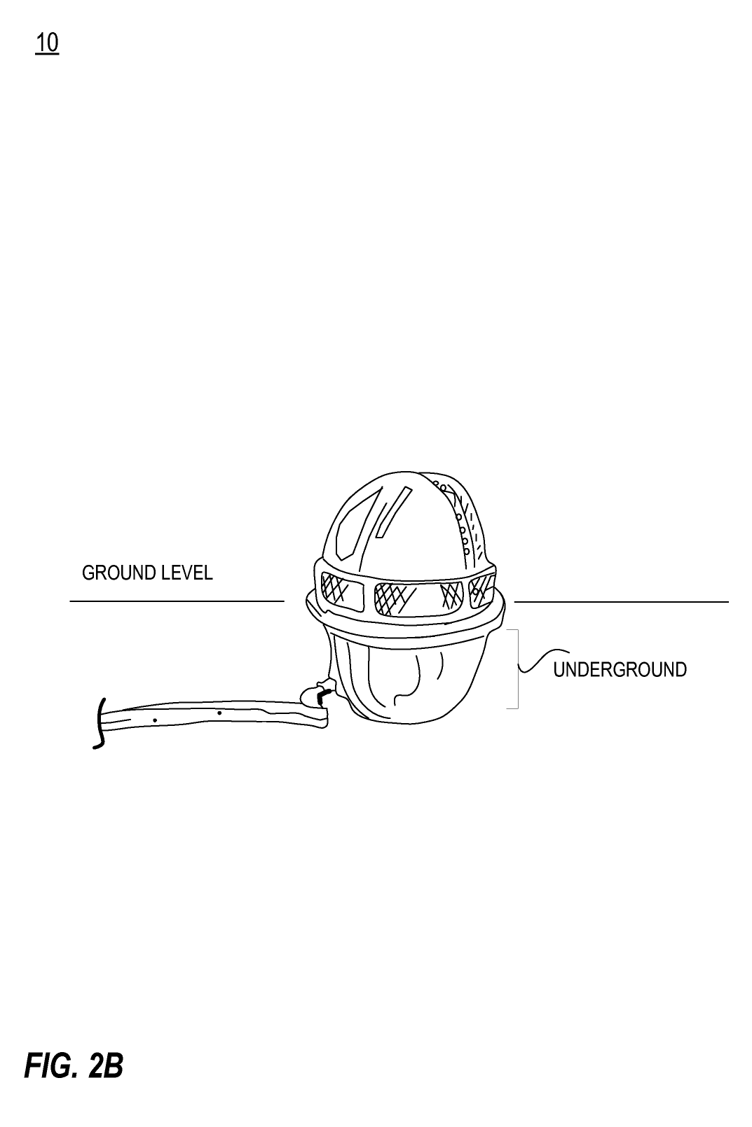

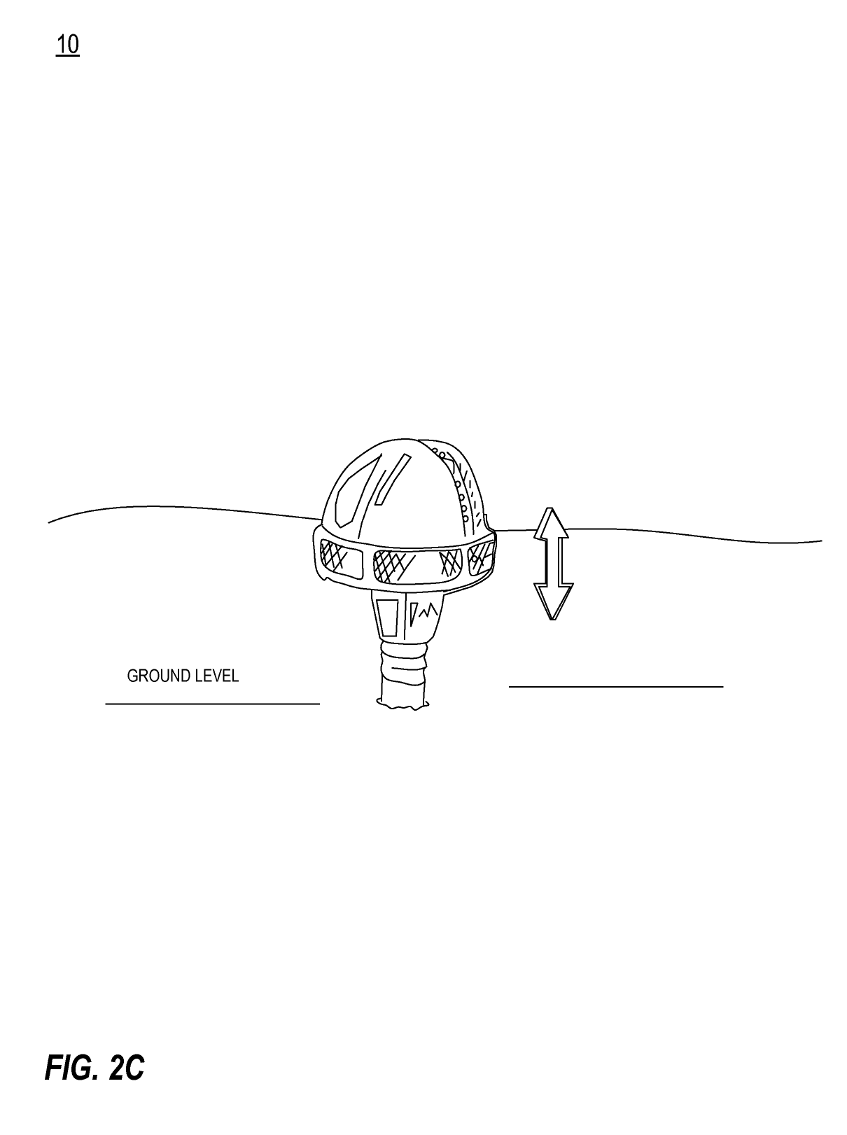

FIGS. 2A-B illustrate a communications and surveillance module 10 in accordance with one or more preferred embodiments of the present invention. The module 10 includes a head 14 and a bulb 16 connected by a stalk 12. The head 14 preferably includes a video camera 22, a microphone 24, speakers 26, and sensors 30. Preferably, the camera 22 is configured for tilting, panning, and zooming.

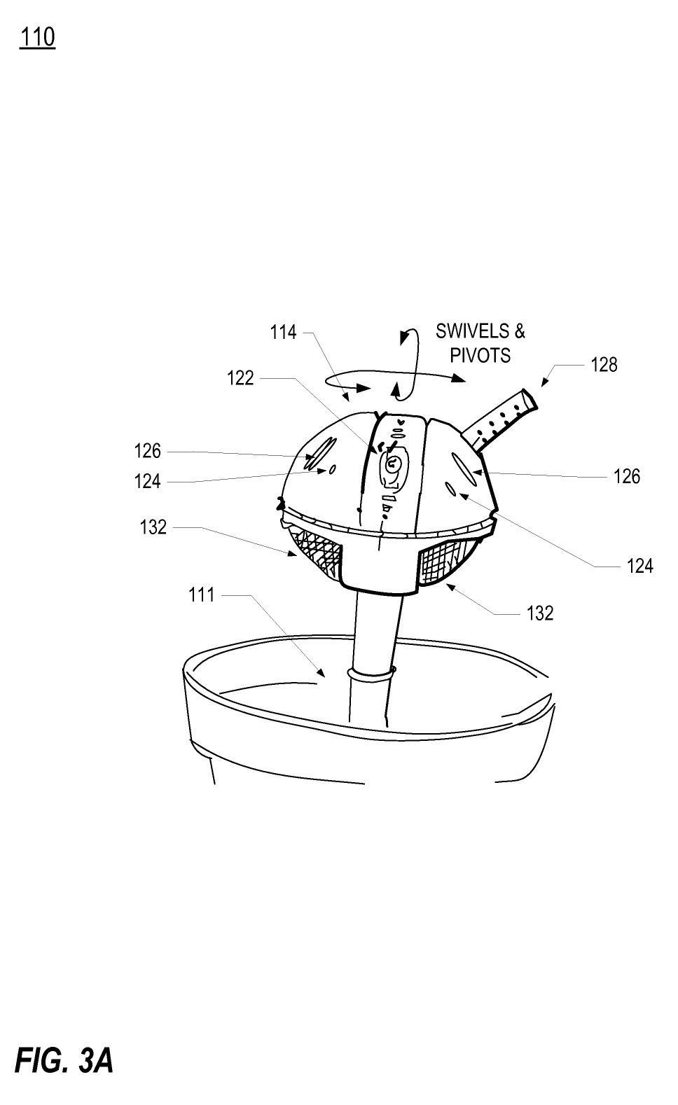

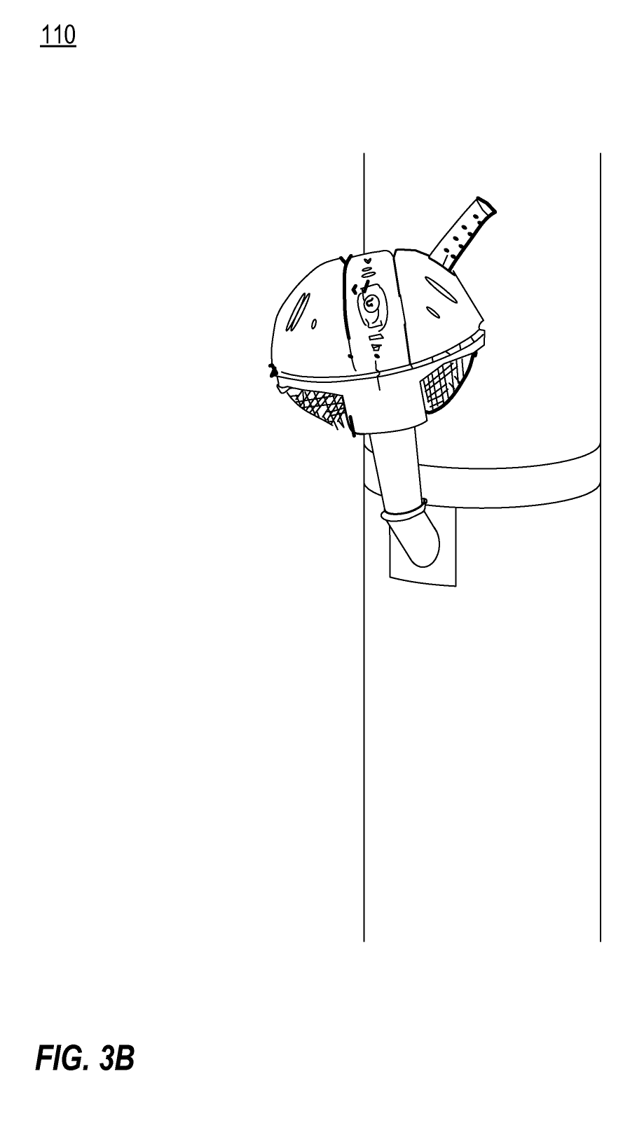

In a preferred embodiment, the bulb 16 of the surveillance module 10 is configured to be positioned, in use, below ground level, where an underground communication and power line 40 is connected to the bulb 16, as can be seen in FIGS. 2A and 2C. However, as illustrated in FIG. 3, not all modules are connected to such a power line or communication. It will be appreciated that in alternative embodiments, a module may utilize a battery, and may include an RF transmitter and receiver. Further, in at least some alternative embodiments, rather than being installed in-ground, a module is a stand-alone module.

The module 10 is configured to “pop up”, from a home position, illustrated in FIG. 2B, to an active position, illustrated in FIG. 2A, in which the head 14 is further from the bulb 16 than in the home position. In preferred embodiments, the module 10 rises from underground or grade level. Preferably, when in the active position, i.e. when in its popped up configuration, the module 10 provides surveillance of a surrounding area.

The module 10 is configured to pop up from its home position to its active position, i.e. is configured for activation, upon the occurrence of one or more triggers. Preferably, a processor is utilized to implement this functionality. For example, in a preferred implementation, a module 10 includes a sensor 30 configured to detect motion, and the module 10 is configured for activation upon sensing motion. Alternatively, or additionally, a user can effect activation prior to motion detection, e.g., by pressing a button.

FIG. 3A illustrates a communications and surveillance module 110 having a head 114 connected to a stake 111. The head 114 preferably includes a video camera 122, a microphone 124, a speaker 126, and motion sensors 132. The head 114 is preferably configured to swivel and pivot with respect to the stake 111, as illustrated in FIG. 3A. Further, the camera 122 is preferably configured for tilting, panning, and zooming. The stake 111 is preferably configured for insertion into soil. Like the module 10, the module 110 is configured for activation upon occurrence of one or more triggers. However, unlike the module 10, the module 110 is not configured to pop up.

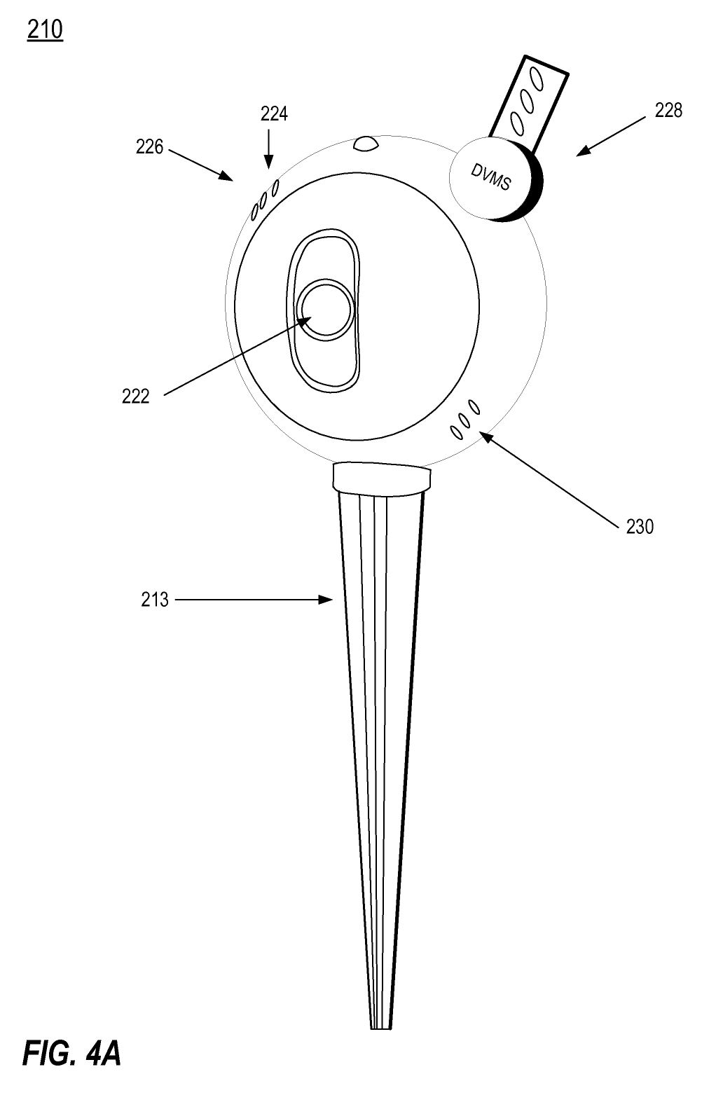

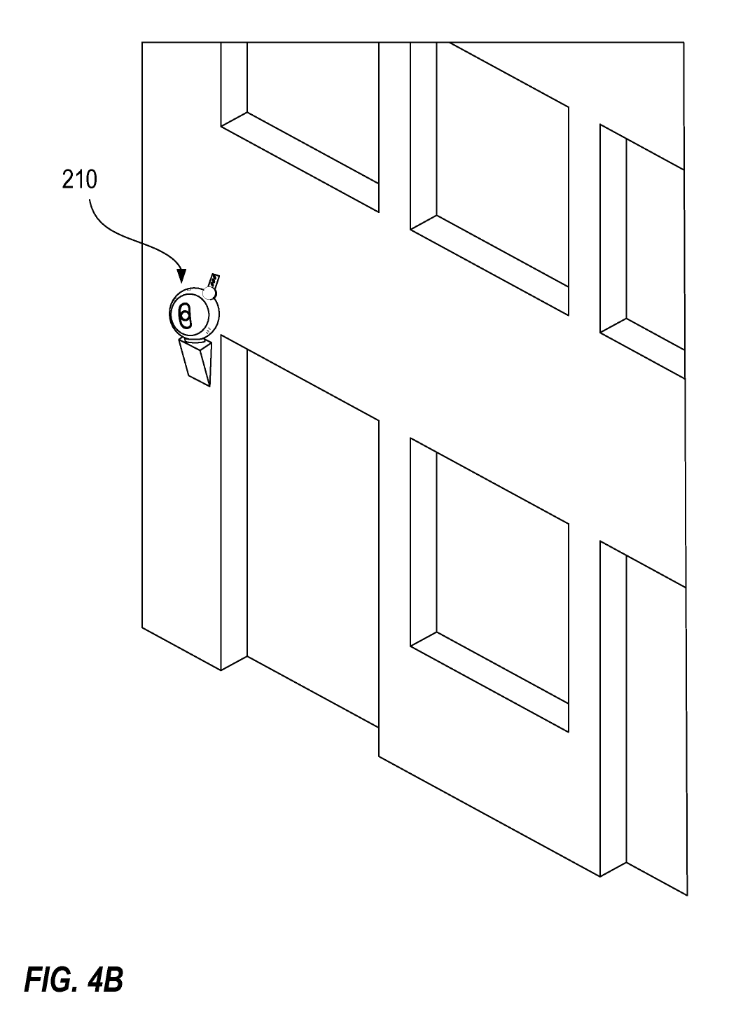

FIG. 4A illustrates a similar communications and surveillance module 210 having a head 214 connected to a spike 213. The head 214 preferably includes a video camera 222, a microphone 224, speakers 226, and sensors 230. Preferably, the camera 222 is configured for tilting, panning, and zooming. Like the module 110, the module 210 is configured for activation upon occurrence of one or more triggers, but is not configured to pop up.

It will be appreciated that, although the modules 110 and 210 are illustrated as including, respectively, a stake 111 and spike 213 for insertion into soil or ground, each could instead be practiced in the absence of these respective elements and configured for attachment to a structure, such as, for example, a pole, as illustrated in FIG. 3B, or a building (which may comprise a construction trailer), as illustrated in FIG. 4B.

In at least some preferred embodiments, the modules 10,110,210 comprise DVMS modules as disclosed in one or more of the incorporated references, and/or include DVMS module functionality disclosed in one or more of the incorporated references.

### Communications and Surveillance

Returning to FIG. 1, the computer system 1012 is preferably in electronic communication with each module 1010 (which may comprise a module 10,110,210), either via a router 1032 as illustrated, or directly. Such electronic communications can be either wired or wireless.

Further, one or more of the peripheral devices preferably comprise remote devices 1070, each of which may either be a handheld device, such as a PDA, or a fixed device, such as a personal computer. FIG. 1 illustrates exemplary remote devices 1070 connected to the computer system 1012 via the PSTN or the Internet. Alternatively, or additionally, one, or more, of the peripheral devices of the system 1000 is a dedicated device 1034. The dedicated device 1034 is preferably in electronic communication with the router 1032, as illustrated in FIG. 1.

The system 1000 preferably is configurable to accommodate an assortment of components. The components may include both hardware and software components. Software components of the system may be updated periodically with enhancements, and may even be reconfigured as necessary. The software is designed to communicate, locate, monitor, observe, and educate persons in contact with the system.

In a preferred embodiment, one or more components are software driven. A software driven module 1010 may be updated, modified, and customized for even more robust applications. Such a software driven module 1010 preferably includes a processor.

In a preferred embodiment, the computer system 1012 includes a DVMS database application which coordinates multiple peripheral devices of the system 1000, and further allows a user to define responses to prompts and events, such as, for example, events that trigger activation of one or more modules 1010.

Preferably, upon activation of a module 1010, two way communication is provided between the module 1010 and a remote device 1070 or dedicated device 1034. The two way communication preferably includes both audio and visual components utilizing the camera, microphone, and speakers of the module 1010, but in alternative embodiments may include only audio components or only visual components.

Additionally, or alternatively, upon activation of a module 1010, surveillance of an area proximate the module 1010 is effected via the camera of the module 1010. Video recorded by the camera of the module 1010 is preferably viewable on a remote device 1070 or dedicated device 1034, for example as part of two way communications. Further, the camera of the module 1010 is preferably configured to tilt, pan, and zoom.

Video communicated from the camera of the module 1010, as well as other data, such as audio, communicated from the module 1010, is preferably stored on a storage device, such as a hard drive, of the computer system 1012. Preferably, upon activation of a module 1010, the camera of the module 1010 records video indicative of what caused its activation.

Further, in at least some embodiments utilized in a security context, activation will effect recording and allow for assessment and, if necessary, effect dispatching of additional assistance.

In a preferred embodiment, one of the peripheral devices of the system 1000 is a module activator 1080. The module activator 1080 comprises hardware configured to activate one or more modules 1010. It will be appreciated that the module activator 1080 is configured for electronic communications with each of the modules 1010 it is configured to activate or deactivate. In at least some preferred embodiments, modules 1010 are configured to function collectively, and the module activator 1080 is configured to activate such collectively functioning modules 1010. Preferably, a user can activate one or more modules 1010 by pressing a button.

The module activator 1080 is preferably further configured for electronic communications with the computer system 1012, dedicated device 1034, and one or more remote devices 1070 via the Internet, as illustrated in FIG. 1. Further, as also illustrated in FIG. 1, other remote devices 1070 are preferably indirectly connected to the module activator 1080 via the computer system 1012. Such electronic communications allow a remote user to activate one or more modules 1010, via the module activator 1080, using the computer system 1012, a remote device 1070, or a dedicated device 1034.

### Exemplary Use Scenarios

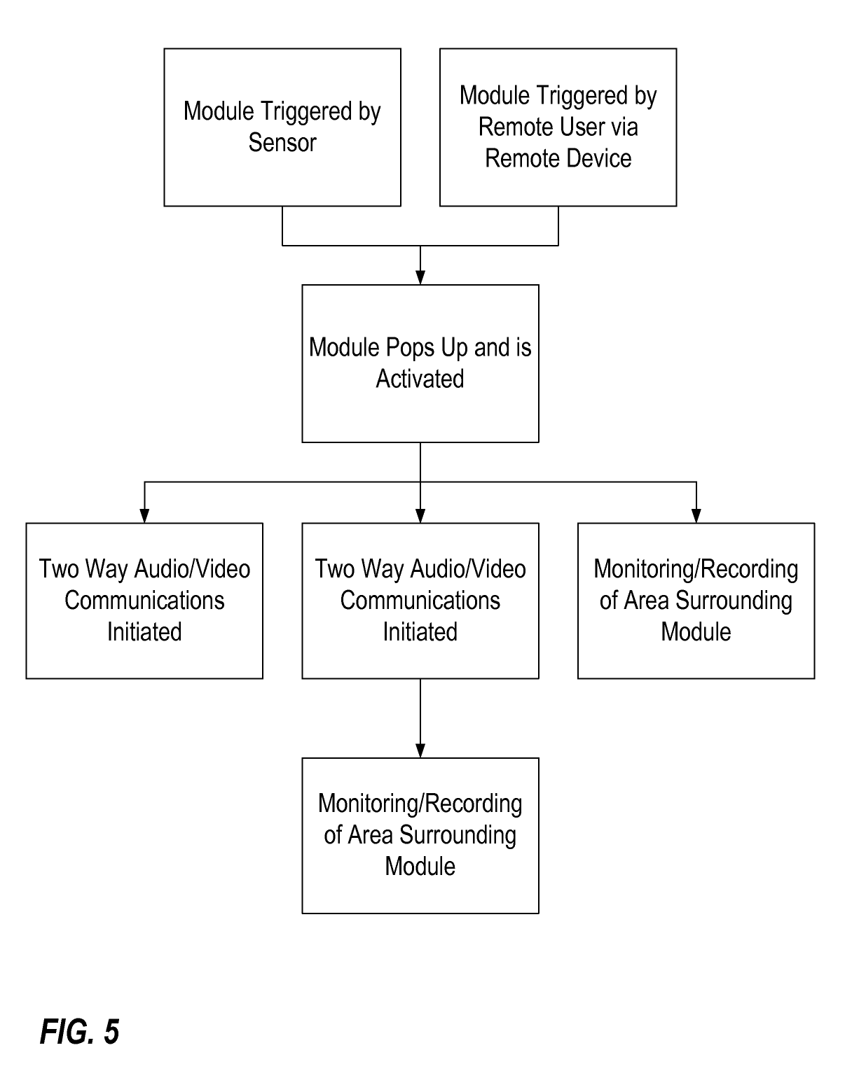

FIGS. 5, 6, and 7A-B illustrate exemplary use scenarios for communications and surveillance systems in accordance with one or more preferred embodiments.

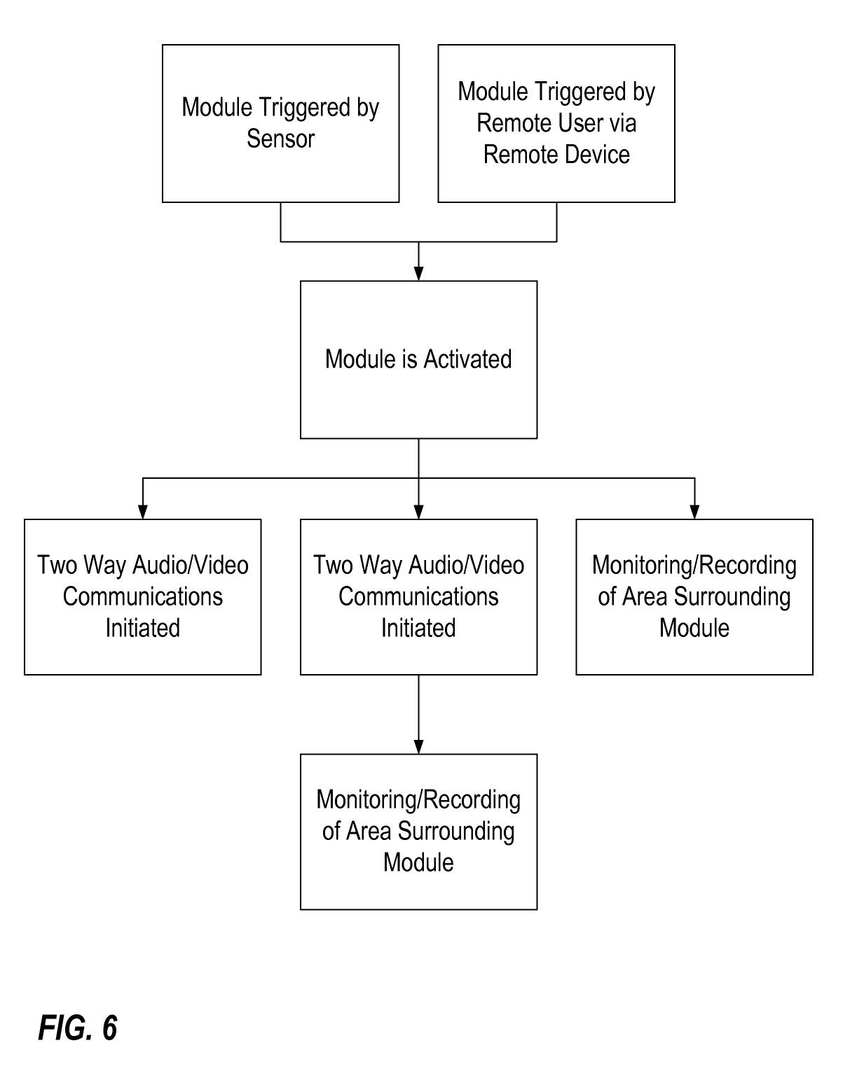

More specifically, FIG. 5 illustrates an exemplary use scenario for a system employing pop up modules 10. A module 10 can be triggered by either a sensor, or a remote user via a remote device. The system can be configured such that, upon being triggered, either two way communications are initiated, monitoring and/or recording is initiated, or both. FIG. 6 illustrates a similar use scenario involving a module 1010 that is not configured to pop up.

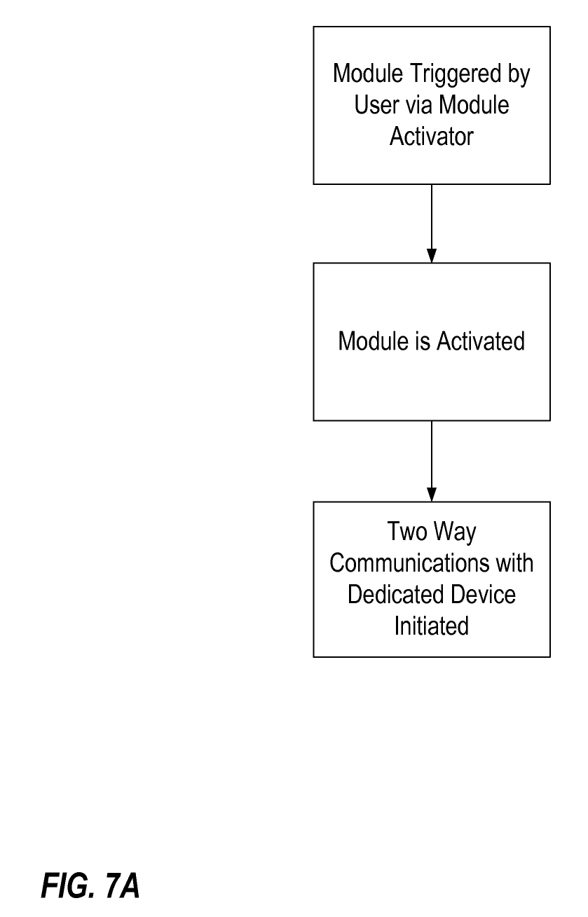

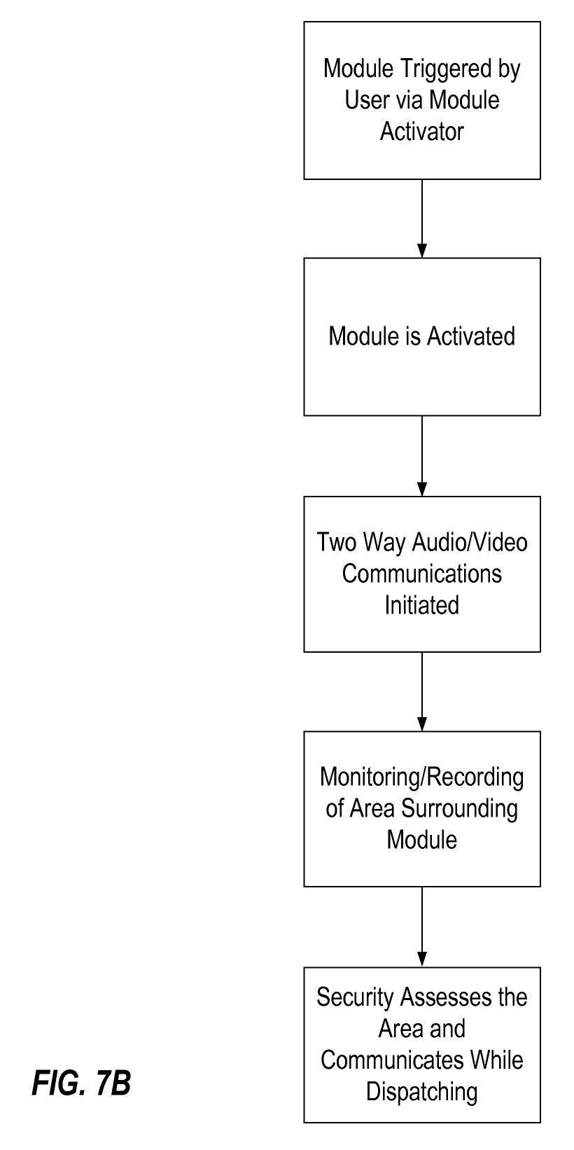

FIG. 7A illustrates an exemplary use scenario for use in a construction context, and more specifically in a pre-construction context, i.e. before construction is completed. In such a context, a user preferably associates a particular dedicated device 1034 with a specific area or development, and the dedicated device 1034 is configured to monitor the status of that specific area or development. For example, a module 1010 could be deployed at a construction site early in the construction process, a development superintendent could be assigned a dedicated device 1034, and users at that module 1010 could communicate with the development superintendent via the dedicated device 1034. FIG. 7A illustrates such communication utilizing a module 1010 and a dedicated device 1034.

It will be appreciated that, after construction is completed, the system could be reconfigured to provide monitoring and surveillance upon triggering of the system, as illustrated in FIG. 7B.

It will further be understood that the above scenarios are exemplary in nature, and that the configurability of systems in accordance with one or more preferred embodiments allows for a wide variety of additional use scenarios.

### DVMS System

It will be appreciated from the above description, and the disclosure of the incorporated references, that modules 1010 in accordance with one or more preferred embodiments include functionality provided by Digital Video Monitoring System (DVMS) modules as disclosed in the incorporated references. Accordingly, in one or more preferred embodiments, a DVMS system includes one or more exterior DVMS modules comprising communications and surveillance modules 1010, which may comprise a module 10,110,210.

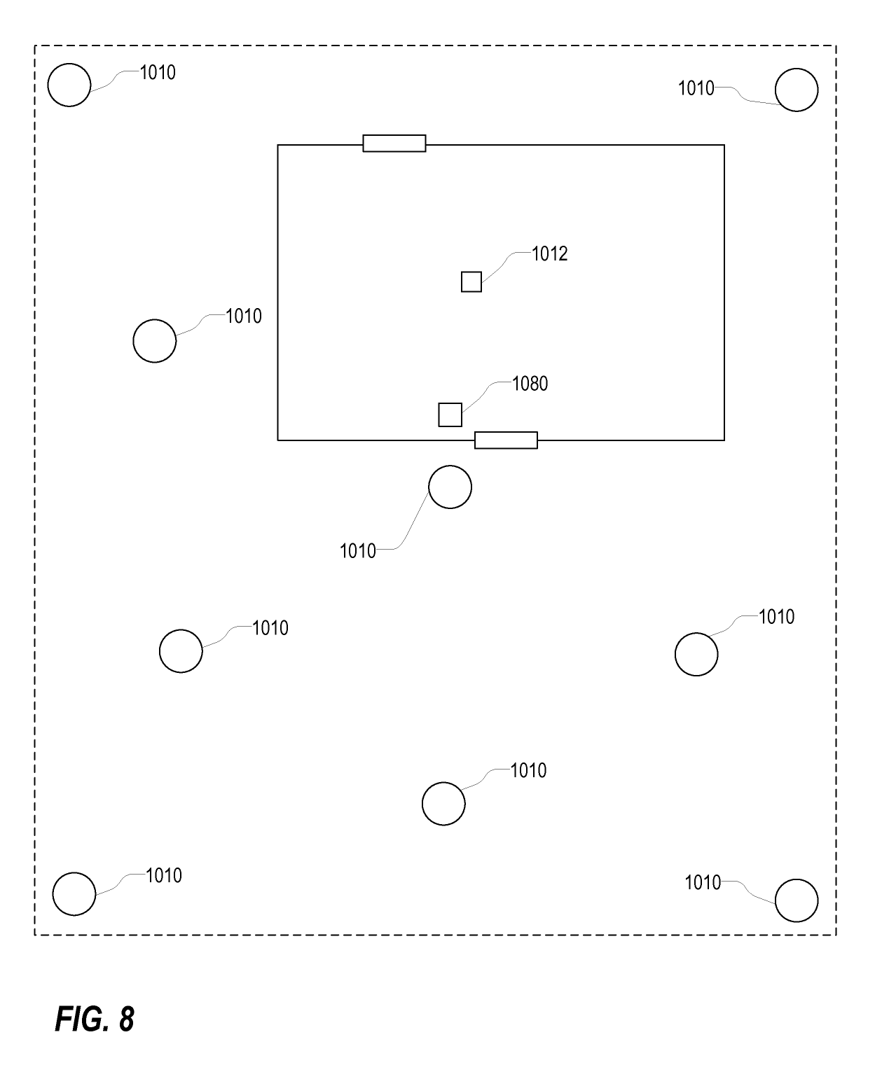

FIG. 8 illustrates an exemplary DVMS system including a plurality of modules 1010, a computer system 1012, and a module activator 1080, in which the modules 1010 are distributed throughout the yard of a residential property.

Preferably, configurable software allows modules 1010 of the plurality of modules 1010 to be placed in multiple locations for effective surveillance of an area. Notably, when utilized as exterior DVMS modules, these modules 1010 may be placed at any location, and not just at an entrance. Each module 1010 may function independently or collectively depending on how a user chooses to utilize the modules.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

1-22. (canceled)

23. A surveillance system comprising:
(a) a module;
(b) wherein the module is designed to have two configurations:
(i) a first configuration, and
(ii) a second configuration, in which the module is positioned vertically above where the module is positioned in the first configuration,
(iii) wherein the module may transition between the first configuration and the second configuration by popping upwards, and may further transition between the second configuration and the first configuration by retracting downwards.

24. The surveillance system of claim 23, wherein the module further comprises a camera.

25. The surveillance system of claim 24, wherein the camera can pan, tilt, and zoom.

26. The surveillance system of claim 23, wherein the module further comprises a microphone.

27. The surveillance system of claim 23, wherein the module monitors an area surrounding the module.

28. The surveillance system of claim 23, wherein two way communication is possible between the module and a remote device.

29. The surveillance system of claim 28, wherein the remote device is a handheld device.

30. The surveillance system of claim 28, wherein the remote device is a dedicated device.

31. The surveillance system of claim 23, wherein a surrounding area of the module is displayed to a remote device.

32. The surveillance system of claim 31, wherein the remote device is a handheld device.

33. The surveillance system of claim 31, wherein the remote device is a dedicated device.

34. The surveillance system of claim 23, further comprising a pole, and wherein the module is attached to the pole.

35-47. (canceled)

48. A communications and surveillance system comprising:
(a) a computer system including a storage device;
(b) one or more communications and surveillance modules, each module comprising a video camera, a microphone, a speaker, and a sensor, wherein
(i) each module includes an active configuration, in which the camera and microphone capture video and audio of an area proximate the module, and an inactive configuration, in which the camera and microphone do not so capture video and audio, and
(ii) each module is configured to transition from the inactive configuration to the active configuration upon sensing of motion by the motion sensor;
(c) a remote device;
(d) wherein the system is configured for electronic communications of video and audio captured by the one or more communications and surveillance modules to the remote device.

49. The system of claim 48, wherein the system is configured for electronic communications of video and audio captured by the one or more communications and surveillance modules to the remote device via the computer system.

50. The system of claim 48, wherein the system further comprises a router, and wherein the system is configured for electronic communications of video and audio captured by the one or more communications and surveillance modules to the remote device via a router.

51. The system of claim 48, wherein the system is configured for electronic communications of video and audio captured by the one or more communications and surveillance modules to the remote device via a wireless RF link.

52. The system of claim 48, wherein the system is configured for electronic communications of video and audio captured by the one or more communications and surveillance modules to the remote device via a WiFi link.

53. The system of claim 48, wherein the one or more modules are configured to collectively transition to the active configuration upon sensing of motion by the motion sensor of any of the modules.

54-76. (canceled)

77. A method for communicating with a person at a remote area, comprising:
(a) sensing, by a motion sensor of a surveillance module, motion;
(b) transitioning, by the surveillance module, from a home configuration, in which a head of the surveillance module is disposed generally in abutment with a bulb of the surveillance module, to an active configuration, in which a head of the surveillance module is not disposed generally in abutment with the bulb;
(c) capturing, by a video camera of the surveillance module, video of an area proximate the surveillance module;
(d) capturing, by a microphone of the surveillance module, audio proximate the surveillance module;
(e) communicating, from the surveillance module, data representative of the captured video and audio;
(f) receiving, at the surveillance module, data representative of speech;
(g) playing, over a speaker of the surveillance module, the speech;
(h) transitioning, by the surveillance module, from the active configuration to the home configuration.

78-84. (canceled)
